(19) United States
(12) Patent Application Publication
(10) Pub. No.: US 2014/0102897 A1
(43) Pub. Date: Apr. 17, 2014

(54) THREE COMPARTMENT ELECTROCHEMICAL CELL

(71) Applicant: NISSAN NORTH AMERICA, INC., Franklin, TN (US)

(72) Inventors: Gregory Jerkiewicz, Farmington Hills, MI (US); Kevork Adjemian, Birmingham, MI (US); Diane Beauchemin, Farmington Hills, MI (US); Liyan Xing, Farmington Hills, MI (US); Mohammad Hossain, Farmington Hills, MI (US)

(73) Assignee: NISSAN NORTH AMERICA, INC., Franklin, TN (US)

(21) Appl. No.: 13/650,264

(22) Filed: Oct. 12, 2012

(51) Int. Cl. G01N 27/30; G01N 27/40

(52) U.S. Cl. 204/408; 204/412; 204/400; 204/415

(57) ABSTRACT

Disclosed herein are embodiments of an apparatus for analysis of electrochemical dissolution. One embodiment comprises a working electrode submerged in a first reaction chamber containing liquid electrolyte, a counter electrode submerged in a second reaction chamber containing liquid electrolyte, a reference electrode submerged in a third reaction chamber and electrolytically connected to the working electrode and an ion conductor electrolytically connecting the first reaction chamber and the second reaction chamber while physically separating the first reaction chamber and the second reaction chamber.

### TECHNICAL FIELD

This disclosure relates in general to an apparatus for measuring catalyst stability, and in particular to a three-electrode electrochemical cell having a divided reaction chamber.

### BACKGROUND

During an electrochemical experiment employing a conventional three-electrode electrochemical cell, the working electrode and the counter electrode mimic anodic and cathodic regions in a proton-exchange membrane fuel cell. As the potential of the working electrode is varied over a pre-determined range, the potential of the counter electrode adjusts spontaneously so that the same total current flows through the anodic and cathodic regions. The electrolyte in which the working electrode and counter electrode are submerged are in constant physical contact and can freely mix. Thus, any soluble compounds generated at the working electrode and/or the counter electrode remain in the common electrolyte and the origin of one or more specific soluble compounds generated at the working electrode and/or the counter electrode cannot be attributed to electrochemical reactions or phenomena taking place at either electrode. In other words, one cannot readily determine whether a soluble compound found in the electrolyte solution originated from the working electrode and/or the counter electrode.

### SUMMARY

Disclosed herein are embodiments of an apparatus for analysis of electrochemical dissolution. One embodiment comprises a working electrode submerged in a first reaction chamber containing liquid electrolyte, a counter electrode submerged in a second reaction chamber containing liquid electrolyte, a reference electrode submerged in a third reaction chamber and electrolytically connected to the working electrode and an ion conductor electrolytically connecting the first reaction chamber and the second reaction chamber while physically separating the first reaction chamber and the second reaction chamber.

Another embodiment of an apparatus for analysis of electrochemical dissolution comprises a first reaction chamber containing liquid electrolyte, a second reaction chamber containing liquid electrolyte, wherein the liquid electrolyte in the first reaction chamber and the liquid electrolyte in the second reaction chamber are in electrolytic contact but are physically separated and a third reaction chamber containing liquid electrolyte, wherein the liquid electrolyte in the third reaction chamber and the liquid electrolyte in the first reaction chamber are in electrolytic contact.

These and other aspects of the present disclosure are disclosed in the following detailed description of the embodiments, the appended claims and the accompanying figures.

### BRIEF DESCRIPTION OF THE DRAWINGS

The various features, advantages and other uses of the present apparatus will become more apparent by referring to the following detailed description and drawing in which:

FIG. 1 is a schematic of an embodiment of a three compartment three-electrode electrochemical cell as disclosed herein;

FIG. 2 is an enlarged view of the ion conductor in FIG. 1;

FIG. 3 is a schematic of another embodiment of a three compartment three-electrode electrochemical cell as disclosed herein;

FIG. 4 is a schematic of yet another embodiment of a three compartment three-electrode electrochemical cell as disclosed herein; and

FIG. 5 is a table of inductively coupled plasma mass spectrometry (ICP-MS) data of electro-dissolved platinum in both a conventional three-electrode electrochemical cell and a three compartment three-electrode electrochemical cell under a variety of potential regimes.

### DETAILED DESCRIPTION

Three-electrode electrochemical cells using stationary electrode or rotating disk electrode measurements can be used in the evaluation of catalysts, referred to herein also as electrocatalysts, such evaluation including stability, as a non-limiting example. The main components of the three-electrode electrochemical cell includes: (i) a reaction chamber containing liquid electrolyte; (ii) three electrodes made of electronically conducting materials such as platinum that is typically mounted in either glass or Teflon®; and (iii) a gas delivery system for purging a neutral or reactive gas through the electrolyte as required. The gas used for purging can be pre-saturated with water vapor to maintain a constant electrolyte level in the reaction chamber.

The first of the three electrodes is the working electrode, also known as the electrocatalyst, catalyst, test or indicating electrode. This is the electrode at which the electrochemical phenomena (reduction or oxidation) being investigated are taking place. The second functional electrode is the reference electrode. This is the electrode whose potential is constant enough that it can be taken as the reference standard against which the potentials of the other electrodes present in the cell can be measured. The final functional electrode is the counter electrode, which serves as a source or a sink for electrons so that current can be passed from the external circuit through the cell. In general, the actual potential of the counter electrode is typically not measured.

Conventionally, the reaction chamber of a three-electrode electrochemical cell is a two-compartment cell, with the working electrode (WE) and counter electrode (CE) placed in the first compartment and the reference electrode (RE) placed in the second compartment. The liquid electrolytes in which the WE and CE are submerged are in constant physical contact and can freely mix. Thus, any soluble compounds generated at the WE and/or the CE remain in the common liquid electrolyte and the origin of one or more specific soluble compounds generated at the WE and/or the CE cannot be attributed to electrochemical reactions or phenomena taking place at a particular electrode. In other words, one cannot readily determine whether a soluble compound found in the electrolyte solution originated from the WE and/or the CE.

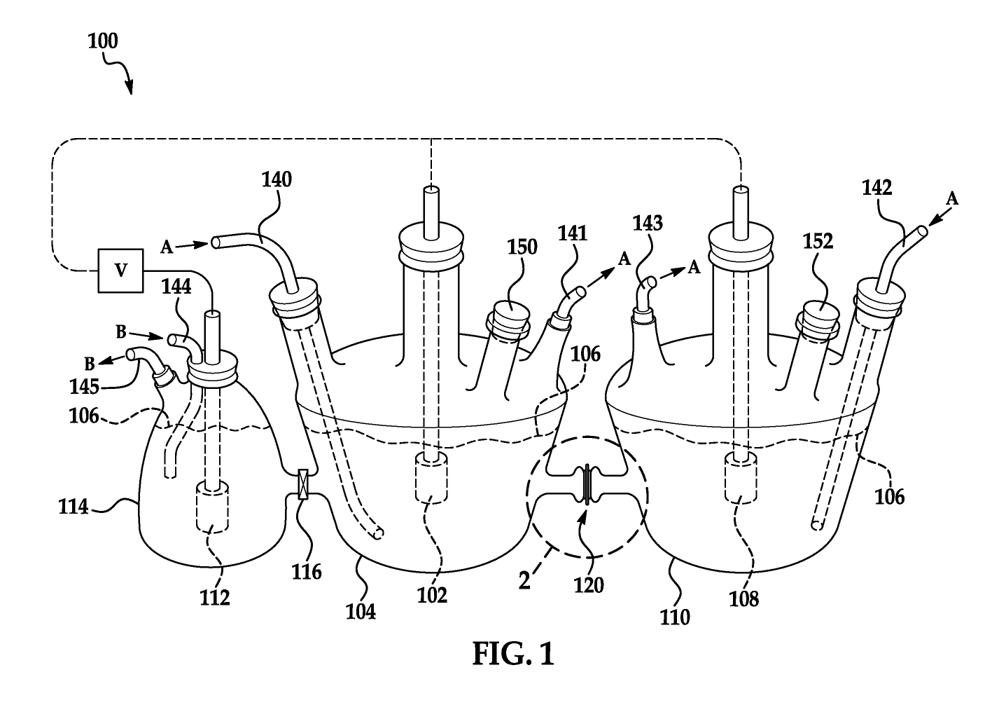

Disclosed herein are embodiments of a three-compartment three-electrode electrochemical cell. One embodiment of a three-compartment three-electrode electrochemical cell 100 shown in FIG. 1 comprises a first reaction chamber 104 containing liquid electrolyte 106, a second reaction chamber 110 containing liquid electrolyte 106 and a third reaction chamber 114 containing liquid electrolyte 106. The liquid electrolyte 106 in the first reaction chamber 104 and the liquid electrolyte 106 in the second reaction chamber 110 are in electrolytic contact but are physically separated; and the liquid electrolyte 106 in the third reaction chamber 114 and the liquid electrolyte 106 in the first reaction chamber 104 are in electrolytic contact but are physically separated.

The three-compartment three-electrode electrochemical cell apparatus 100 further comprises a WE 102 submerged in the first reaction chamber 104 containing liquid electrolyte 106, a CE 108 submerged in the second reaction chamber 110 containing liquid electrolyte 106 and an RE 112 submerged in the third reaction chamber 114 containing liquid electrolyte 106 and electrolytically connected through connection 116 to the WE 102. Connection 116 can be a porous glass, a porous membrane, or a stop cock with a small opening, as non-limiting examples, so long as electrolytic contact is maintained but the electrolytes 106 in the first and third reaction chambers 104, 114 do not mix. The connection 116 does not have to be below the electrolyte 106 level. The connection can be through the vapor space in each of the first and third chambers 104, 114, alternatively.

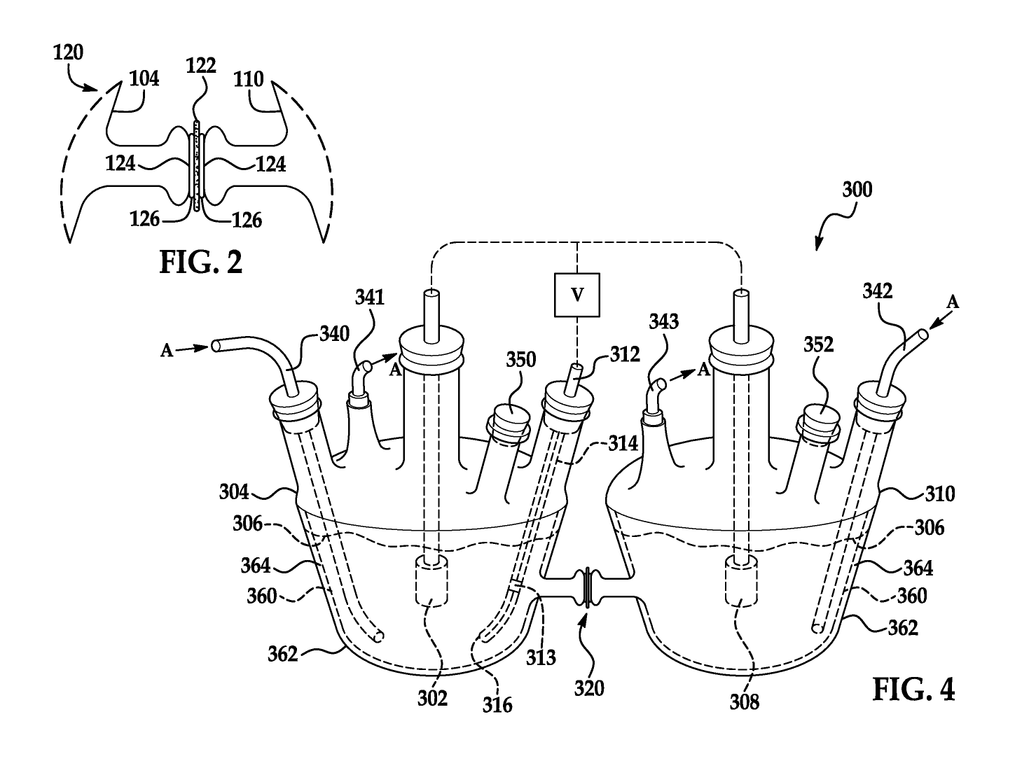

An ion conductor 120 (ions being proton, hydronium, hydroxide and others) electrolytically connects the first reaction chamber 104 and the second reaction chamber 110 providing electrolytic contact while physically separating the first reaction chamber 104 and the second reaction chamber 110. The ion conductor 120 is described with more detail with reference to FIG. 2.

Delivery conduit 140 provides a neutral or reactive gas A that is bubbled into the liquid electrolyte 106 of the first reaction chamber 104. Conduit 141 provides an exit for gas A. A separate delivery conduit 142 can provide neutral or reactive gas A that is bubbled in to the liquid electrolyte 106 of the second reaction chamber 110, but is not required. Conduit 143 provides an exit for gas A from the second reaction chamber 110. A third delivery conduit 144 is mounted such that gas B is delivered to the RE 112, with conduit 145 providing an exit for gas B. Gas A can be one of oxygen, hydrogen, chlorine, argon and nitrogen and fluid B is hydrogen, each a non-limiting example. Gas B may not be necessary if the RE 112 is not a hydrogen RE.

The electrodes are made of electronically conducting materials. Each of the WE, CE and RE can comprise platinum. As a non-limiting example, the CE and WE can be made of platinum foil or platinum mesh, while the RE can be made of platinum covered with platinum black, or nanometric particles deposited on platinum wire, foil or mesh. The WE and CE can also be dissimilar electronically conducting materials. The WE can be a stationary electrode or can be a rotating-disk or rotating-disk-ring electrode that is rotated to provide stirring to the electrolyte solution 106. The liquid electrolyte 106 can be an acidic solution such as perchloric acid, sulfuric acid, phosphoric or trifluoromethanesulfonic acid, as non-limiting examples.

The first reaction chamber 104 can have a sample port 150 configured to take a sample of the liquid electrolyte 106 in the first reaction chamber 104. The second reaction chamber 110 can also have a sample port 152 configured to take a sample of the liquid electrolyte in the second reaction chamber 110. Both sample ports 150, 152 form a seal when closed to prevent leakage of fluid from the chambers or to prevent introduction of air from the surrounding atmosphere.

FIG. 2 is an enlarged view of the ion conductor 120 in FIG. 1. The ion conductor 120 is a membrane 122 sealingly positioned between openings 124 below the liquid electrolyte 106 levels in both the first reaction chamber 104 and second reaction chamber 110. Gaskets such as 0-rings 126 can be used to seal the membrane 122 to the respective opening 124 on each side. The membrane 122 is a material that facilitates the electrolytic contact between the first reaction chamber 104 and the second reaction chamber 110, easily transporting hydrogen (H⁺) ions, the main ionic species responsible for electrical current flow through the electrolyte. However, the membrane 122 material must also be mainly impermeable to metallic and other ions dissolved in the liquid electrolyte 106, preventing migration of the metallic and other ions between the first reaction chamber 104 and the second reaction chamber 110. Non-limiting examples of material for use as the membrane 122 are perfluorosulfonic acid (PFSA) membranes and porous glass. The porous glass could be in the form of a disc or a plug.

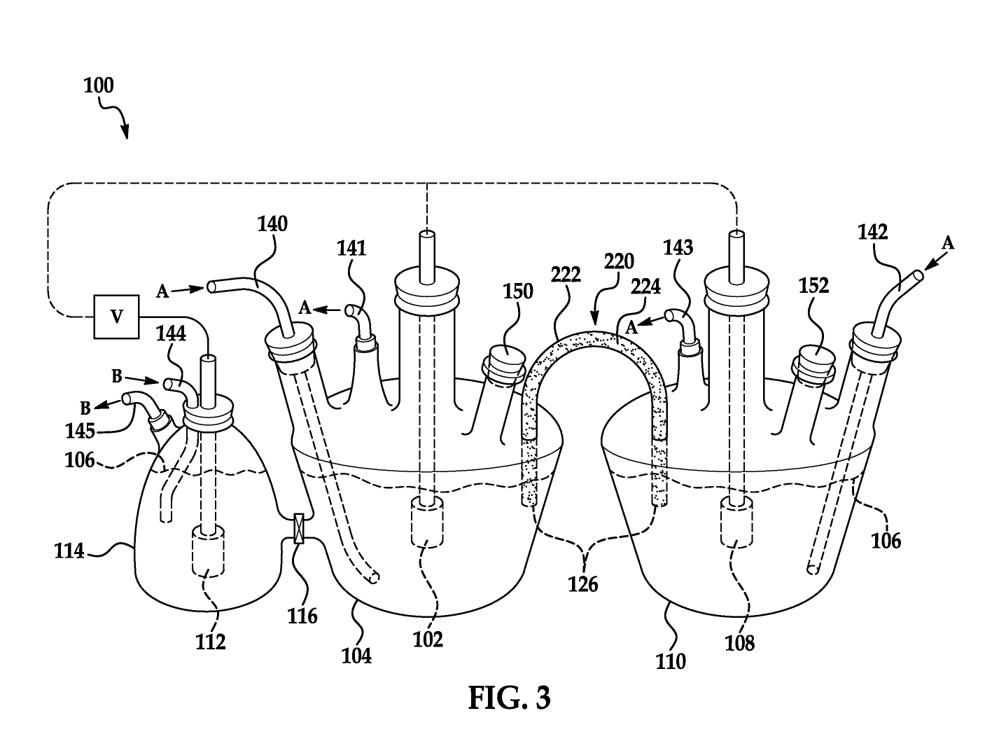

FIG. 3 is another embodiment of the three-compartment three-electrode electrochemical cell 100. FIG. 3 is similar to FIG. 1; however, the ion conductor 220 shown in FIG. 3 is a salt bridge 222 connecting the liquid electrolyte 106 of the first reaction chamber 104 and the liquid electrolyte 106 of the second reaction chamber 110. The salt bridge 222 can have various geometries, such as the U-shaped tube placed upside down as shown in FIG. 3. The salt bridge 222 contains highly conductive electrolyte 224 physically enclosed from the liquid electrolyte 106 of both the first reaction chamber 104 and the second reaction chamber 110. The highly conductive electrolyte 224 can be physically enclosed from the liquid electrolyte 106 of both the first reaction chamber 104 and the second reaction chamber 110 with porous glass 126 or a permeable membrane, for example. The highly-conducting electrolyte 224 can be aqueous solutions of NaCl, KCl, NaNO₃ or KNO₃ as non-limiting examples. Agar can be added to the electrolyte 224 in the salt bridge 222 to create a gel. The gel and the porous glass 126 would prevent the electrolyte 224 in the salt bridge 222 from mixing with the electrolytes 106 in the first reaction chamber 104 and second reaction chamber 110.

FIG. 4 is another embodiment of the three-compartment three-electrode electrochemical cell. In FIG. 4, a three-compartment three-electrode electrochemical cell apparatus 300 for use in a laboratory comprises a WE 302 submerged in a first reaction chamber 304 containing liquid electrolyte 306 and a CE 308 submerged in a second reaction chamber 310 containing liquid electrolyte 306. An ion conductor 320 electrolytically connects the first reaction chamber 304 and the second reaction chamber 310, providing electrolytic contact while physically separating the first reaction chamber 304 and the second reaction chamber 310. The ion conductor 320 can be any embodiment disclosed herein.

The third reaction chamber 314 with the RE 312, shown here as a platinum wire, is submerged in the liquid electrolyte 306 in the first reaction chamber 304. The third reaction chamber 314 can be a glass tube that narrows down to a capillary-sized opening or can have porous glass or a permeable membrane near the submerged end such that the RE is electrolytically connected to the WE, defining a clear sensing point 316 for the RE near the WE. As a non-limiting example, the capillary can be a Luggin capillary. It is not necessary to provide hydrogen to the RE 312, as hydrogen gas can be produced between the glass plug 313 and the sensing point 316 before testing.

Fluid A is bubbled into the liquid electrolyte 306 of the first reaction chamber 304 through delivery conduit 340 and exits the first reaction chamber 304 through conduit 341. A separate delivery conduit 342 can bubble fluid A in the liquid electrolyte 306 of the second reaction chamber 310, with fluid A exiting through conduit 343, but is not required. Fluid A can be one of oxygen, hydrogen, chlorine, argon and nitrogen, each a non-limiting example.

The first reaction chamber 304 can have a sample port 350 configured to take a sample of the liquid electrolyte 306 in the first reaction chamber 304. The second reaction chamber 310 can also have a sample port 352 configured to take a sample of the liquid electrolyte 306 in the second reaction chamber 310. Both sample ports 350, 352 form a seal when closed to prevent leakage of fluid from the chambers or to prevent introduction of air from the surrounding atmosphere.

Any of the embodiments herein can further comprise means for adjusting a temperature of both the first reaction chamber 104, 304 and the second reaction chamber 110, 310. For example, in FIG. 4 the first reaction chamber 304 and the second reaction chamber 310 each have a double-wall shown as the inner wall 360 and the outer wall 362 forming a cavity 364 there between. A non-limiting example of the means for adjusting the temperature is a heated or cooled liquid circulated within the cavity 364 within the double-wall. Other examples of the means for adjusting the temperature include, but are not limited to, submerging at least the first reaction chamber 104, 304 and the second reaction chamber 110, 310 with single walls in a hot water or ice bath, using heat tape on the outside of the first reaction chamber 104, 304 and the second reaction chamber 110, 310, placing the entire apparatus 100, 300 in an oven, a refrigerator and the like.

Providing a means for adjusting the temperature facilitates variable-temperature measurements. By circulating a heating or cooling fluid, such as water or alcohol from an externally placed circulator, the temperature of the first reaction chamber 104, 304 and second reaction chamber 110, 310 can be controlled over a broad range and to within ±0.5°. The temperature range is determined by the freezing and boiling points of the electrolyte. Because electrochemical reactions and phenomena are sensitive to temperature variations and because proton exchange membrane fuel cells (PEMFC) operate at elevated temperatures, the application of a temperature controlled three-compartment three-electrode electrochemical cell allows examination of precious metal catalyst degradation over a broad temperature range, from slightly above the electrolyte freezing point to slightly below the electrolyte boiling point.

The three-compartment three-electrode electrochemical cells disclosed herein are ideally suited to measure electro-dis solved platinum originating from the WE and CE in the form of dissolved Pt^{z+}-containing ions, where z is the oxidation state of platinum and z=2 or 4. The three-compartment three-electrode electrochemical cell can be employed to study platinum electro-dissolution in aqueous electrolytes with the use of inductively coupled plasma-mass spectrometry (ICP-MS) to identify and quantify the amount of platinum in the liquid electrolytes 106, 306 in each of the first reaction chamber 104, 304 and the second reaction chamber 110, 310. The three-compartment three-electrode electrochemical cell testing allowed for the determination that both the WE and the CE undergo electro-dissolution upon potential variation, such as potential cycling. Application of a standard multi-meter during potential cycling experiments allowed for monitoring the potential that the CE spontaneously adopted as the potential of the WE was scanned in a programmed manner. Unexpectedly, the potential of the CE was often higher than that of the WE, indicating that the CE can also electro-dissolve.

Moreover, because the potential of the CE was often determined to be higher than that of the WE, the conclusions to draw include (i) that the electro-dis solution of the CE can occur simultaneously with electro-dis solution of the WE, and (ii) that under certain experimental conditions, a majority of electro-dis solved platinum originates from the CE rather than from the WE as previously thought by those skilled in the art. In other words, the programmed cycling of the potential of the WE creates favorable conditions for greater electro-dissolution of the CE rather than of the WE. This observation is of significance to PEMFC technology because it indicates that both electrodes within a PEMFC can electro-dis solve. In addition, the results suggest that (i) the potentials of both the WE and the CE in PEMFCs have to be monitored in order to assess the susceptibility of each electrode to electro-dissolution, (ii) suitable PEMFC operating conditions have to be selected in order to minimize the electro-dis solution of each electrode and (iii) novel procedures for mitigating precious metal electro-dissolution have to be designed in order to maximize the lifetime of precious metal electrocatalysts used in the membrane electrode assemblies (MEA) of PEMFCs.

Prior to the electrochemical experiments using the three-compartment three-electrode electrochemical cell that resulted in the conclusions above, both a conventional two compartment three-electrode electrochemical cell and a three-compartment three-electrode electrochemical cell were cleaned using a well-established method developed in the laboratory of the late Prof. B. E. Conway and found in H. Angerstein-Kozlowska, Ch. 1 in “Comprehensive Treatise of Electrochemistry”, E. Yeager, J. O'M. Bockris, B. E. Conway and S. Sarangapani, Eds., Vol. 9, Plenum Press, New York (1984).) Both cells were rinsed with de-ionized water and soaked in a mixture of concentrated nitric acid (HNO₃) and concentrated sulfuric acid (H₂SO₄) in a 1:1 ratio by volume for over 24 hours. The cells were then drained of the acid mixture and rinsed at least ten times with de-ionized water, soaked in de-ionized water for several hours and then again rinsed with de-ionized water.

For conducting the experiment, the liquid electrolyte used was 0.5 M aqueous H2SO4. It was prepared from concentrated, ultra-high purity H₂SO₄ and de-ionized water purified using a two-stage Millipore™ system. Each of the electrodes were thoroughly cleaned by: (i) degreasing in acetone under reflux for three hours; (ii) rinsing with de-ionized water; (iii) soaking in a mixture of concentrated HNO₃ and concentrated H₂SO₄ for three hours; (iv) rinsing with de-ionized water; and (v) storing in concentrated H₂SO₄. Prior to use, the electrodes were rinsed with de-ionized water and then with the electrolyte.

The embodiment of the three-compartment three-electrode electrochemical cell has the ion conductor made of a Nafion® membrane. The Nafion® membrane was soaked in 0.5 M aqueous H₂SO₄ overnight and then placed in the three-compartment three-electrode electrochemical cell. A new Nafion® membrane was used for each experiment. Each cell was outgassed with high-purity nitrogen for thirty minutes prior to each experiment.

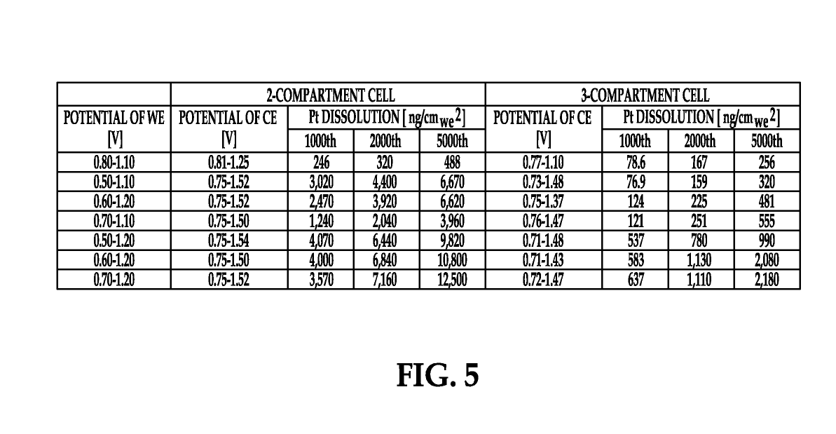

The WE was cycled in a potential range of 0.05-1.4V to obtain a “clean” CV and an aliquot of ca. 1.0 mL of electrolyte was taken and served as a blank. Potential cycling of the WE between various potential limits at a scan rate of s=50 mV s¹ was initiated immediately thereafter in both cells. The potential of the CE adjusts spontaneously to allow the same overall current. The electrolyte in the WE compartment was continuously stirred with a magnetic stirrer. An aliquot of ca. 1.0 mL of electrolyte was taken at the following cycles: 20th, 50th, 100th, 200th, 500th, 1000th, 2000th, 3000th, 4000^{th} and 5000^{th}. The cell volume was kept constant by adding ca. 1.0 mL of fresh electrolyte, with a correction for the addition made in the dissolution calculations. The electrolyte samples were 5-fold diluted before submission for ICP-MS measurements. As shown in the table in FIG. 5, the results indicate a significant difference in the dissolution attributed to the WE between the traditional two-compartment three-electrode electrochemical cell and the three-compartment three-electrode electrochemical cell as disclosed herein.

The three-compartment three-electrode electrochemical cells disclosed herein can also be used in corrosion studies. In corrosion phenomena, two or more dissimilar metals, metallic alloys of other conducting or semiconducting materials (e.g. semiconductors) are in contact. The less-noble material acts as an anode and undergoes oxidation producing oxidation products that might be soluble. The more-noble material acts as a cathode and facilitates reduction reactions. The reduction reaction might involve soluble compounds that upon reduction deposit on the cathode, precipitate or remain soluble.

The products of oxidation require identification and quantification. The products of reduction lead to depletion of the compound that undergoes reduction and generation of a new compound or compounds. The three-compartment three-electrode electrochemical cells could be effectively used in such studies because the three-compartment three-electrode electrochemical cells prevent the products of oxidation and reduction reactions from mixing due to the ion conductor 120, 220, 320 between the first reaction chamber 104, 304 and second reaction chamber 110, 310. The application of the three-compartment three-electrode electrochemical cells allows identification of the reactants and products of corrosion reactions.

The three-compartment three-electrode electrochemical cells creates suitable experimental conditions for the quantification of electro-dis solved precious metals originating from: (i) the WE alone, (ii) the CE alone and (iii) both the WE and the CE by combining the outcomes of the two separate measurements. The experimental setup also prevents electro-dissolved precious metal originating from the WE from depositing on the CE and vice versa. This latter issue is important because operation of PEMFC leads to changes in the morphology of precious metal catalysts. These changes are assigned to (i) the agglomeration of small nanoparticles into large ones through the so-called Oswald ripening and/or (ii) the electro-dissolution of precious metal followed by its subsequent electro-deposition. Because morphology changes have been reported using traditional three-electrode electrochemical cells, the exact nature of the process(es) leading to morphological changes of precious metal catalysts cannot be unambiguously identified. Consequently, most previously reported results are likely incorrect. Therefore, the application of the three-compartment three-electrode electrochemical cells disclosed herein allow identification and quantification of the real phenomena that lead to morphological changes of PEMFC catalysts.

The apparatus shown and described herein can be used in a laboratory setting. It is also contemplated that variations of the embodiments herein be used in commercial large scale fuel cell systems to monitor the fuel cell systems while in use, for example, in energy plants.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. An apparatus for analysis of electrochemical dissolution comprising:
a working electrode submerged in a first reaction chamber containing liquid electrolyte;
a counter electrode submerged in a second reaction chamber containing liquid electrolyte;
a reference electrode submerged in a third reaction chamber and electrolytically connected to the working electrode; and
an ion conductor electrolytically connecting the first reaction chamber and the second reaction chamber while physically separating the first reaction chamber and the second reaction chamber.

2. The apparatus of claim 1, wherein the ion conductor is a perfluorosulfonic acid membrane sealingly positioned between openings below a liquid electrolyte level in both the first reaction chamber and second reaction chamber.

3. The apparatus of claim 1, wherein the ion conductor is porous glass positioned between openings below a liquid electrolyte level in both the first reaction chamber and second reaction chamber.

4. The apparatus of claim 1, wherein the ion conductor is a salt bridge connecting the liquid electrolyte of the first reaction chamber and the second reaction chamber, the salt bridge containing highly conductive electrolyte physically enclosed from the liquid electrolyte of the first reaction chamber and the second reaction chamber.

5. The apparatus of claim 4, wherein the highly conductive electrolyte is physically enclosed from the liquid electrolyte of the first reaction chamber and the second reaction chamber with one of porous glass and a permeable membrane.

6. The apparatus of claim 1 further comprising means for adjusting a temperature of both the first reaction chamber and the second reaction chamber.

7. The apparatus of claim 6, wherein the first reaction chamber and the second reaction chamber have double-walls and the means for adjusting the temperature is a liquid circulated within the double-walls.

8. The apparatus of claim 1, wherein the third chamber having the reference electrode is a glass tube submerged in the liquid electrolyte in the first reaction chamber and electrolytically connected to the first reaction chamber through an end of the glass tube.

9. The apparatus of claim 1, wherein the working electrode, the counter electrode and the reference electrode comprise platinum.

10. The apparatus of claim 9, wherein the working electrode is a rotating disk electrode.

11. The apparatus of claim 1, wherein the working electrode and the counter electrode are dissimilar metal.

12. The apparatus of claim 1, wherein the first reaction chamber has a sample port configured to take a sample of the liquid electrolyte in the first reaction chamber and the second reaction chamber has a sample port configured to take a sample of the liquid electrolyte in the second reaction chamber.

13. An apparatus for analysis of electrochemical dissolution comprising:
a first reaction chamber containing liquid electrolyte;
a second reaction chamber containing liquid electrolyte, wherein the liquid electrolyte in the first reaction chamber and the liquid electrolyte in the second reaction chamber are in electrolytic communication but are physically separated; and
a third reaction chamber containing liquid electrolyte, wherein the liquid electrolyte in the third reaction chamber and the liquid electrolyte in the first reaction chamber are in electrolytic contact.

14. The apparatus of claim 13 further comprising:
a working electrode submerged in the liquid electrolyte of the first reaction chamber;
a counter electrode submerged in the liquid electrolyte of the second reaction chamber; and
a reference electrode submerged in the liquid electrolyte of the third reaction chamber.

15. The apparatus of claim 14, wherein the third reaction chamber with the reference electrode is a glass tube submerged in the liquid electrolyte in the first reaction chamber, the glass tube having a capillary-sized opening that provides the electrolytic contact.

16. The apparatus of claim 13 further comprising:
a perfluorosulfonic acid membrane having a first side forming a sealing engagement with an opening of the first reaction chamber and a second side forming a sealing engagement with the opening of the second reaction chamber, the perfluorosulfonic acid membrane providing electrolytic contact and physical separation between the liquid electrolyte in the first reaction chamber and the liquid electrolyte in the second reaction chamber.

17. The apparatus of claim 13 further comprising:
a porous glass having a first side forming a sealing engagement with an opening of the first reaction chamber and a second side forming a sealing engagement with the opening of the second reaction chamber, the porous glass providing electrolytic contact and physical separation between the liquid electrolyte in the first reaction chamber and the liquid electrolyte in the second reaction chamber.

18. The apparatus of claim 13 further comprising:
a salt bridge containing highly conductive electrolyte having a first end in contact with the liquid electrolyte of the first reaction chamber and a second end in contact with the liquid electrolyte of the second reaction chamber, the salt bridge providing electrolytic contact and physical separation between the liquid electrolyte in the first reaction chamber and the liquid electrolyte in the second reaction chamber.

19. The apparatus of claim 18, wherein the highly conductive electrolyte is physically enclosed in the salt bridge with porous glass at each of the first end and second end.

20. The apparatus of claim 13 further comprising means for adjusting a temperature of both the first reaction chamber and the second reaction chamber.

21. The apparatus of claim 20, wherein the first reaction chamber and the second reaction chamber have double-walls and the means for adjusting the temperature is a liquid circulated within the double-walls.
